(19) United States
(12) Patent Application Publication
(10) Pub. No.: US 2007/0183155 A1
(43) Pub. Date: Aug. 9, 2007

(54) Decorative entertaining unit

(76) Inventor: Thomas Chen, Chino, CA (US)

Correspondence Address: Raymond Y. Chan, Suite 128, 108 N. Ynez Avenue, Monterey Park, CA, 91754, US

(21) Appl. No.: 11/704,737

(22) Filed: Feb. 8, 2007

Related U.S. Application Data
(60) Provisional application No. 60/771,938, filed on Feb. 8, 2006.

(51) Int. Cl. F21V 23/04

(52) U.S. Cl. 362/276

(57) ABSTRACT

A decorative entertaining unit includes a decorative ornament body and an entertaining unit. The decorative ornament body has a base portion attached on a user's body, and a decorative portion extended from the base portion, wherein the decorative portion has a predetermined aesthetic appearance for serving general decorative function. The entertaining unit is embedded into the decorative ornament body, and comprises an illuminating unit adapted to operate between a normal mode and an enhanced decoration mode, wherein in the normal mode, the illuminating unit is deactivated to allow plain decoration from the decorative ornament body, wherein in the enhanced decoration mode, the illuminating unit is activated to generate a predetermined pattern of illumination so as to provide an illuminating decorative effect of the decorative ornament body.

### CROSS REFERENCE OF RELATED APPLICATION

This is a regular application of a provisional application, having an application No. 60/771,938 and a filing date of Feb. 8, 2006.

### BACKGROUND OF THE PRESENT INVENTION

1. Field of Invention

The present invention relates to decorative item, and more particularly, relates to a kind of self-entertaining, handy, small, exquisite and convenient decorative entertaining unit which is wearable, and serviceable for varying purposes.

2. Description of Related Arts

Nowadays, decorative ornaments have been widely used for a variety of purposes. Such decorative ornaments are commonly wearable, or otherwise incorporated, affixed, attached onto apparel, toys, books, greeting cards, hats, bags, or any means to enhance the overall aesthetic effect for the items. One of the most available ornaments is the ribbon flower, which has been overwhelmingly used for wrapping boxes, adorning hats and apparels, decorating books and journals, and for facilitating the Christmas trees.

However, there are no supplemental functions have been added into such ornaments. People probably would discard such temporary ornaments afterwards. On the other hand, somebody wish to decorate the Christmas trees with such decorative illumination ornaments. The extended ultra long electrical wires and complicated installation procedures obstructed such efforts.

Therefore, it is desirable to develop a kind of decorative entertaining unit ornaments supplemented with illumination functions or otherwise any entertaining functions to hit the market of tremendous convenience.

### SUMMARY OF THE PRESENT INVENTION

A main object of the present invention is to provide a decorative entertaining unit, wherein the ornament is wearable and serviceable so as to provide the user an entertainment function reinforced ornament.

Another object of the present invention is to provide a decorative entertaining unit, wherein the entertaining unit is self powered by battery source so as to ensure the decorative ornament to be independent and handy in decorating applications.

Another object of the present invention is to provide a decorative entertaining unit, wherein the entertaining unit is invisible perched within the ornament body so as to guarantee the overall aesthetic appearance of the decorative ornament would not be affected.

Another object of the present invention is provide a decorative entertaining unit, wherein the entertaining unit is integrally packaged, such that the entertaining means, such illuminators, voice transmitters, music recorder would be well protected in practices.

In order to accomplish above objects, the present invention provides a decorative entertaining unit, comprising:

an decorative ornament body having a base portion attached on a user's body, and a decorative portion extended from the base portion, wherein the decorative portion has a predetermined aesthetic appearance for serving general decorative function; and

an entertaining unit which is embedded into the decorative ornament body, and comprises an illuminating unit adapted to operate between a normal mode and an enhanced decoration mode, wherein in the normal mode, the illuminating unit is deactivated to allow plain decoration from the decorative ornament body, wherein in the enhanced decoration mode, the illuminating unit is activated to generate a predetermined pattern of illumination so as to provide an illuminating decorative effect of the decorative ornament body.

These and other objectives, features, and advantages of the present invention will become apparent from the following detailed description, the accompanying drawings, and the appended claims.

### BRIEF DESCRIPTION OF THE DRAWINGS

FIG. 1 is perspective view of the decorative entertaining unit according to a preferred embodiment of the present invention.

FIG. 2 is an exploded view of the decorative entertaining unit according to the above preferred embodiment of the present invention.

FIG. 3 is a schematic diagram of the decorative entertaining unit according to the above preferred embodiment of the present invention.

### DETAILED DESCRIPTION OF THE PREFERRED EMBODIMENT

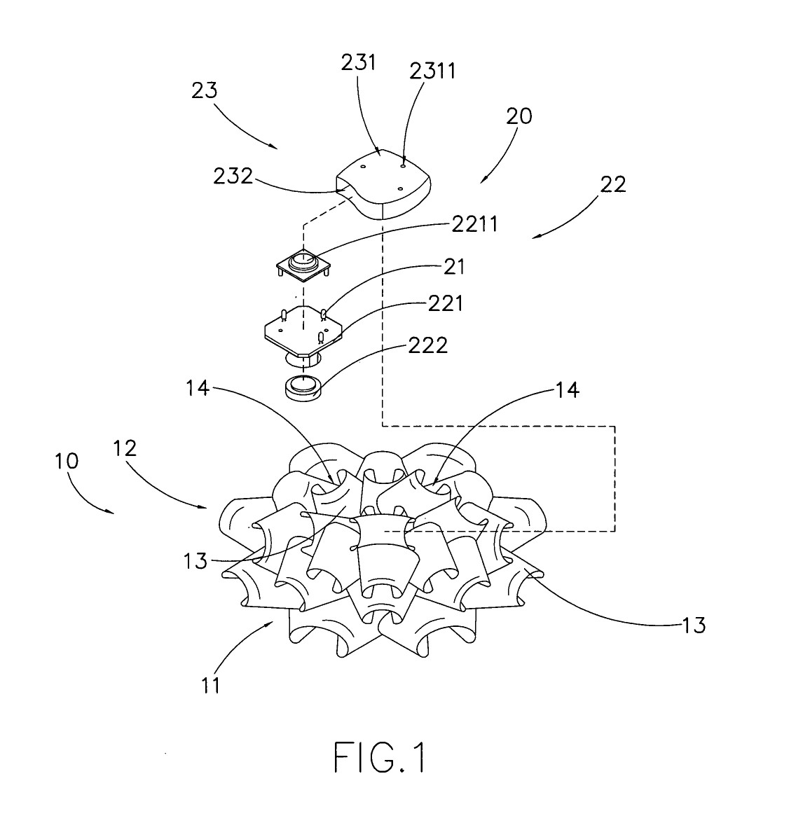

Referring to FIG. 1 of the drawings, a decorative entertaining unit according to a preferred embodiment of the present invention is illustrated, in which the decorative entertaining unit comprise a decorative ornament body 10, and an entertaining unit 20.

The decorative ornament body 10 has a base portion 11 attached on a user's body, and a decorative portion 12 extended from the base portion 11, wherein the decorative portion 12 has a predetermined aesthetic appearance for serving a general decorative function.

The entertaining unit 20 is embedded into the decorative ornament body 10, and comprises an illuminating unit 21 adapted to operate between a normal mode and an enhanced decoration mode, wherein in the normal mode, the illuminating unit 21 is deactivated to allow plain decoration from the decorative ornament body 10, wherein in the enhanced decoration mode, the illuminating unit 21 is activated to generate a predetermined pattern of illumination so as to provide an enhanced illuminating decorative effect of the decorative ornament body 10.

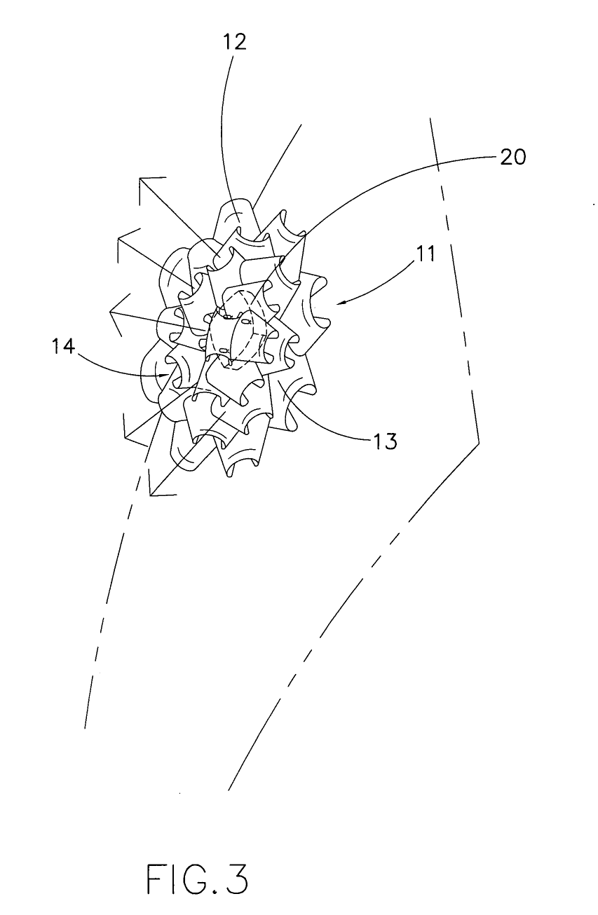

According to the preferred embodiment of the present invention, the base portion 11 of the decorative ornament body 10 is detachably attached onto a user's body so that the present invention is detachably worn onto the user's body, preferably onto the user's clothing, such as the user's jacket or the user's shirt. The decorative portion 12 of the decorative ornament body 10 can be embodied as a wide variety of ornamental structures. Referring to FIG. 1 to FIG. 3 of the drawings, the decorative portion 12 is preferably embodied as forming a decorative flower brooch attached onto the user's shirt or the user's jacket. Thus, the decorative ornament body 10 comprises a plurality of ornamental members 13 intertwined with each other to form the flower brooch decorative portion 12 of the decorative ornament body 10 having a corresponding number of visual holes 14 formed as space between the corresponding ornamental members 13. Thus, when the illuminating unit 21 is in the enhanced decoration mode, the illumination is capable of reaching an exterior of the decorative ornament body 10 via the visual holes 14 so as to produce the enhanced illuminating decorative effect. In other words, the present invention is adapted to provide a kind of entertaining service to handy, exquisite, and small decorative items, such as a flower brooch, a decorative festoon, ribbon flowers, and so on. It is worth mentioning that each of the ornamental members 13 is partially light-admissible so that when the illuminating units 21 are illuminating, the ornamental members 13 are highlighted to optimize the enhanced illuminating decorative effect.

It is worth mentioning that the decorative ornament body 10 can be detachably attached onto the user's cloth by an external connector, such as a connecting pin. As a slight alternative, however, the decorative ornament body 10 can further comprise a detachable connector 16 provided at a rear side thereof for detachably connecting the decorative ornament body 10 with the user's cloth. The detachable connector 16 can be embodied as a connecting pin, or an adhesive layer.

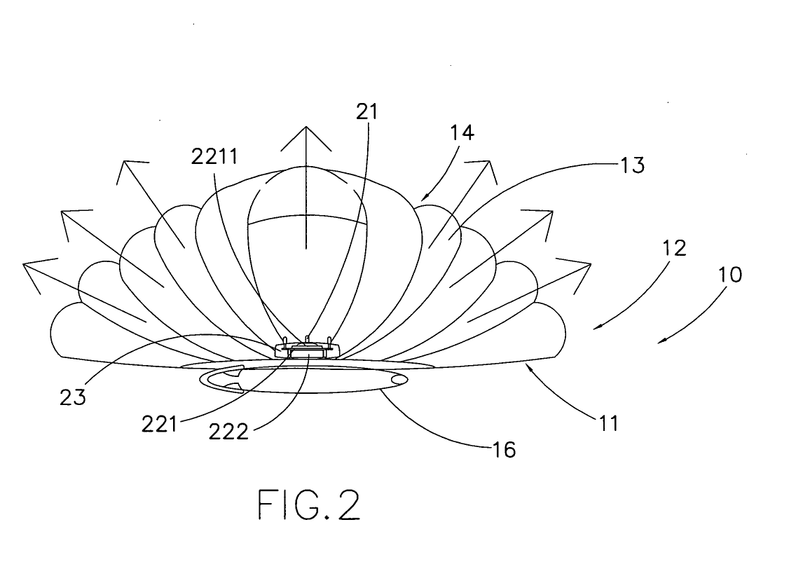

The entertaining unit 20 is embedded within the decorative ornament body 10 for supplementing the decorative purposes. As shown in FIG. 2 of the drawings, the entertaining unit 20 is embodied as a LED illumination unit invisibly received within the decorative portion 12 for projecting illumination for the flowers brooch. Accordingly, the entertaining unit 20 comprises a plurality of illuminating units 21 spacedly positioned within the decorative portion 12 of the decorative ornament body 10, and a portable power unit 22 embedded within the decorative portion 12 to electrically connect with illuminating units 21 for electrically activating them to generate illumination. It is worth mentioning that in order not to jeopardize the enhanced illuminating decorative effect of the present invention, the entertaining unit 20 further comprises a decorative holder 23, having an appearance akin to that of the decorative portion 12 of the decorative ornament body 10, embedded within the decorative portion 12 to securely hold the illuminating units 21 and the portable power unit 22 in position.

More specifically, the decorative holder 23 has an outer skin 231 having the same color with the decorative portion 12 of the decorative ornament body 10, and a receiving cavity 232 formed within the outer skin 231 for securely receiving the portable power unit 22. In other words, the decorative holder 23 is made of the same material of the ornamental member 13 and the color of the outer skin 231 matches with the color of the ornamental member 13 so as to hide the entertaining unit 20 at the decorative ornament body 10. It is worth mentioning that the bottom side of the decorative holder 23 can be mounted at the decorative ornament body 10 by a double-sided tape or the like at a position the entertaining unit 20 is embedded within the decorative portion 12 of the decorative ornament body 10.

Moreover, the outer skin 231 has a plurality of through retaining holes 2311 spacedly formed thereon wherein the illuminating units 21 are electrically connected with the portable power unit 22 within the receiving cavity 232 and are securely retained at the retaining holes 2311 respectively. In other words, each head portion of the illuminating units 21 is protruded from the outer skin 231 of the decorative holder through the respective retaining hole 2311 for producing illumination at the decorative portion 12 of the decorative ornament body 10.

On the other hand, the portable power unit 22 comprises a control unit 221, such as a printed circuit board, provided within the receiving cavity 232, and a portable power source 222, such as a rechargeable battery, also received within the receiving cavity 232 and electrically connected to the control unit 221, in such a manner that the portable power source 222 is arranged to activate the control unit 221 which then activates illumination of the illuminating units 21 in a predetermined pattern.

It is worth mentioning that the control unit 221 further comprises a control switch 2211 provided within the receiving cavity 232 of the decorative holder 23, wherein the user of the present invention is adapted to activate the control switch 2211 from an exterior of the decorative holder 23 for activating the control unit 221. In other words, the user is able to selectively operate the control unit 221 through switching the control switch 2211 so as to selectively operate the illuminating units 21 for producing predetermined pattern of illumination. According to the preferred embodiment of the present invention, the control switch 2211 is embodied as a flip/flop actuating button so that whenever an external force is applied on it, such as a when the button is subject to depression by the user, the control unit 221 will be activated. In other words, the control switch 2211 is supported at the uppermost position within the receiving cavity 232 such that when the depression force is applied on the outer skin 231 of the decorative holder 23, the control switch 2211 is actuated to active the control unit 221.

Each of the illuminating units 21 may further comprise a plurality of emitters for generating a multi-color light. Moreover, the entertaining unit 20 may further comprise a plurality of electrical entertaining units, such as voice generators, voice recorder etc for providing a wider range of entertaining options for the user of the present invention. In other words, the present invention provides a kind of convenient handy self-entertaining ornament, which is adapted to combine certain entertaining functions, such as lighting, voice generating, music recording, multimedia processing, and so on into the conventional decorative ornament.

In order to further enhance the illuminating decorative effect of the illuminating units 21, the control unit 221 of the portable power unit 22 is pre-programmed to generate a plurality control signals for activating the illuminating units 21 in such a manner that they illuminate corresponding to the control signals generated by the portable power unit 22. Thus, the portable power unit 22 is capable of controlling the illumination pattern of the illuminating units 21 through different pre-programmed control signals. As an example, activation of the different control signals can be accomplished by subsequent activation of the control switch 2211.

Since the entertaining unit 20 is overall packaged, the decorative portion 12 of the decorative ornament body 10 could be purposely designed to substantially cover such entertaining unit 20 from being seen from outside. As a result, whenever the entertaining unit 20 is in service for performing entertainment function, the overall aesthetic appearance would not be affected. That is to say, the decorative ornament body 10 could be selectively chosen from a variety of shapes for accommodating the entertaining unit 20 in position, and the decorative portion 12 could be extended for protecting the entertaining unit 20 invisible, i.e. the entertaining unit 20 invisibly perched within the decorative ornament body 10 for supplementing a decorative function of the ornament.

It is also worth mentioning that the base portion 11 of the decorative ornament body 10 can be embodied as an attaching strap to be attached onto any wearable subjects or serviceable items, such as apparels, hats, greeting cards, books, photo albums, gift box, baskets, and so on. Moreover, the base portion 11 and the decorative portion 12 of the decorative ornament body 10 are preferably manufactured by light weight materials.

The operation of the present invention is as follows: when the entertaining unit 20 is not operating, i.e. when the illuminating units 21 are in the normal mode, the decorative ornament body 10 can be attached onto the user's cloth as a regular ornamental accessory. When the user wishes to activate the entertaining unit 20 to produce the enhanced illuminating decorative effect, he or she may simply switch on the control switch 2211 which then activates the control unit 22 for controlling illumination of the illuminating units 21 in a pre-programmed manner. In order to change the pattern of illumination, the user may switch off the control switch 2211 and continuously switch on the control switch 2211 once more so as to change the pre-programmed pattern of illumination of the illuminating units 21.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure form such principles. Therefore, this invention includes all modifications encompassed within the spirit and scope of the following claims.

What is claimed is:

1. A decorative entertaining unit, comprising:
an decorative ornament body having a base portion adapted for attaching on a user's body, and a decorative portion extended from said base portion, wherein said decorative portion has a predetermined aesthetic appearance for serving general decorative function; and
an entertaining unit which is embedded into said decorative ornament body, and comprises an illuminating unit being operated between a normal mode and an enhanced decoration mode, wherein at said normal mode, said illuminating unit is deactivated to allow plain decoration from said decorative ornament body, wherein at said enhanced decoration mode, said illuminating unit is activated to generate a predetermined pattern of illumination so as to provide an illuminating decorative effect of said decorative ornament body.

2. The decorative entertaining ornament, as recited in claim 1, wherein said decorative ornament body comprises a plurality of ornamental members intertwined with each other to form a flower brooch decorative portion of said decorative ornament body having a corresponding number of visual holes formed as space between said corresponding ornamental members, wherein when said illuminating units are in said enhanced decoration mode, illumination is capable of reaching an exterior of said decorative ornament body through said visual holes so as to visualize said enhanced illuminating decorative effect.

3. The decorative entertaining ornament, as recited in claim 2, wherein each of said ornamental members is partially light-admissible so that when said illuminating units are activated, said ornamental members are highlighted to optimize said enhanced illuminating decorative effect.

4. The decorative entertaining ornament, as recited in claim 1, wherein said entertaining unit further comprises a decorative holder having an outer skin which has an appearance akin to that of said decorative portion of said decorative ornament body, wherein said decorative holder is embedded within said decorative portion to securely hold said illuminating units and said portable power unit in position, so that said illuminating units and said portable power unit are securely retained at decorative portion in a normally invisible manner.

5. The decorative entertaining ornament, as recited in claim 2, wherein said entertaining unit further comprises a decorative holder having an outer skin which has an appearance akin to that of said decorative portion of said decorative ornament body, wherein said decorative holder is embedded within said decorative portion to securely hold said illuminating units and said portable power unit in position, so that said illuminating units and said portable power unit are securely retained at decorative portion in a normally invisible manner.

6. The decorative entertaining ornament, as recited in claim 3, wherein said entertaining unit further comprises a decorative holder having an outer skin which has an appearance akin to that of said decorative portion of said decorative ornament body, wherein said decorative holder is embedded within said decorative portion to securely hold said illuminating units and said portable power unit in position, so that said illuminating units and said portable power unit are securely retained at decorative portion in a normally invisible manner.

7. The decorative entertaining ornament, as recited in claim 4, wherein said decorative holder further has a plurality of through retaining holes spacedly formed on said outer skin such that head portion of said illuminating units are protruded from and securely retained at said retaining holes respectively.

8. The decorative entertaining ornament, as recited in claim 5, wherein said decorative holder further has a plurality of through retaining holes spacedly formed on said outer skin such that head portion of said illuminating units are protruded from and securely retained at said retaining holes respectively.

9. The decorative entertaining ornament, as recited in claim 6, wherein said decorative holder further has a plurality of through retaining holes spacedly formed on said outer skin such that head portion of said illuminating units are protruded from and securely retained at said retaining holes respectively.

10. The decorative entertaining ornament, as recited in claim 6, wherein said decorative holder is made of the same material of said ornamental member and the color of said outer skin matches with the color of said ornamental member so as to hide said entertaining unit at said decorative ornament body.

11. The decorative entertaining ornament, as recited in claim 9, wherein said decorative holder is made of the same material of said ornamental member and the color of said outer skin matches with the color of said ornamental member so as to hide said entertaining unit at said decorative ornament body.

12. The decorative entertaining ornament, as recited in claim 6, wherein said decorative holder further has a receiving cavity defined underneath said outer skin and comprises a portable power source and a control unit received in said receiving cavity, wherein said control unit is electrically connected between said portable power source and said illumination units and is arranged to activate said illumination units for generating said illuminating decorative effect.

13. The decorative entertaining ornament, as recited in claim 9, wherein said decorative holder further has a receiving cavity defined underneath said outer skin and comprises a portable power source and a control unit received in said receiving cavity, wherein said control unit is electrically connected between said portable power source and said illumination units and is arranged to activate said illumination units for generating said illuminating decorative effect.

14. The decorative entertaining ornament, as recited in claim 11, wherein said decorative holder further has a receiving cavity defined underneath said outer skin and comprises a portable power source and a control unit received in said receiving cavity, wherein said control unit is electrically connected between said portable power source and said illumination units and is arranged to activate said illumination units for generating said illuminating decorative effect.

15. The decorative entertaining ornament, as recited in claim 12, wherein said control unit comprises a control switch which is provided underneath said outer skin and is arranged in such a manner that when an external depression force is applied on said control switch through said outer skin, said control switch is switched on to activate said illuminating units.

16. The decorative entertaining ornament, as recited in claim 13, wherein said control unit comprises a control switch which is provided underneath said outer skin and is arranged in such a manner that when an external depression force is applied on said control switch through said outer skin, said control switch is switched on to activate said illuminating units.

17. The decorative entertaining ornament, as recited in claim 14, wherein said control unit comprises a control switch which is provided underneath said outer skin and is arranged in such a manner that when an external depression force is applied on said control switch through said outer skin, said control switch is switched on to activate said illuminating units.

18. The decorative entertaining ornament, as recited in claim 3, wherein said decorative ornament body further comprises a detachable connector provided at a rear side of said base portion for detachably connecting said decorative ornament body with a user's cloth.

19. The decorative entertaining ornament, as recited in claim 11, wherein said decorative ornament body further comprises a detachable connector provided at a rear side of said base portion for detachably connecting said decorative ornament body with a user's cloth.

20. The decorative entertaining ornament, as recited in claim 17, wherein said decorative ornament body further comprises a detachable connector provided at a rear side of said base portion for detachably connecting said decorative ornament body with a user's cloth.
